(19) United States
(12) Patent Application Publication
(10) Pub. No.: US 2025/0175007 A1
(43) Pub. Date: May 29, 2025

(54) CONTROL DEVICES TO HANDLE UNBALANCED LOADS FOR POWER SOURCES

(71) Applicant: Cummins Power Generation Inc., Minneapolis, MN (US)

(72) Inventors: Timothy M Lewis, Minneapolis, MN (US); Denise Maria Christine Athaide, Fridley, MN (US)

(73) Assignee: Cummins Power Generation Inc., Minneapolis, MN (US)

(21) Appl. No.: 18/523,583

(22) Filed: Nov. 29, 2023

(51) Int. Cl. H02J 3/38; H02J 3/01

(52) U.S. Cl. CPC H02J 3/381; H02J 3/01

(57) ABSTRACT

Presented herein are systems, devices, and methods for handling unbalanced loads for power sources. A controller can receive a plurality of signals to be provided to a plurality of legs of an inverter. The controller can detect specific harmonic frequencies inside a frequency band for a first signal of the plurality of signals. Certain reference frame reflected harmonics are caused by an unbalanced load and other certain harmonics are due to generator spatial harmonics. Both types of harmonics can be suppressed. The controller can determine, responsive to the identification of the unbalanced load or generator harmonics, an adjustment value in accordance with a resonant gain to be applied within the frequency band of the first signal. The controller can modify the first signal using the adjustment value to generate a second signal to provide to a leg of the plurality of legs of the inverter.

### TECHNICAL FIELD

The present disclosure relates generally to power systems, and in particular systems and methods for controlling inverters.

### BACKGROUND

A power system can accept or relay electrical power from various power sources to one or more components electrically coupled therewith. In furtherance of conveying electrical power, the power system can convert the power from direct current (DC) to alternating current (AC), and vice-versa.

### SUMMARY

The present disclosure relates to techniques for suppressing unbalanced harmonics for power inverters. A controller can target harmonics in a reference frame (e.g., a direct-quadrature-zero (dq0) synchronous frame) resulting from unbalanced operations (e.g., due to irregular or non-linear loads). The controller can use a neutral leg of the controller to correct for the imbalance with high dynamic bandwidth. To that end, the controller can have a control loop (e.g., proportional-integral (PI) control) integrated with a filter (e.g., a proportional-resonant band pass filter). This augmentation of the controller can be used to amplify desired frequency bands and suppress other bands associated with unbalanced harmonics. By suppressing harmonics arising from unbalanced operations, the controller can provide a stable voltage and power.

At least one aspect is directed to a controller for handling unbalanced loads for power sources. The controller can include a computer-readable medium having instructions stored thereon. The controller can include at least one processor configured to execute the instructions. The at least one processor can receive a plurality of signals to be provided to a plurality of legs of an inverter. The at least one processor can identify an unbalanced load outside a frequency band for a first signal of the plurality of signals. The at least one processor can determine, responsive to the identification of the unbalanced load, an adjustment value in accordance with a resonant gain to be applied within the frequency band of the first signal. The at least one processor can modify the first signal using the adjustment value to generate a second signal to provide to a leg of the plurality of legs of the inverter.

In some embodiments, the at least one processor can identify, from a plurality of components corresponding to the plurality of signals, a component corresponding to the first signal. In some embodiments, the at least one processor can determine, in accordance with identified component, the frequency band and the resonant gain to apply for the first signal to suppress voltage spatial harmonics.

In some embodiments, the at least one processor can identify the unbalanced load about at least one frequency of a plurality of defined frequencies for the first signal. In some embodiments, the at least one processor can determine, responsive to the identification, a second adjustment value to be applied about the frequency to suppress the unbalanced load.

In some embodiments, the at least one processor can select, based on a component of a plurality of components corresponding to the first signal, a second frequency band within which to scan for the unbalanced load. In some embodiments, the at least one processor can determine that none of the plurality of signals corresponds to a reference signal. In some embodiments, the at least one processor can generate, responsive to determining that none of the plurality of signals corresponds to the reference signal, the reference signal set to a defined value to add to the plurality of signals.

In some embodiments, the at least one processor can transform the plurality of signals in a first domain to a second plurality of signals in a second domain with the addition of at least one reference signal for a corresponding leg of the plurality of legs. The reference signal can be used to balance across the second plurality of signals. In some embodiments, the at least one processor can regulate the first signal via a proportional-integral (PI) controller, parallel to the adjustment value applied to the first signal.

At least one aspect is directed to a system providing electrical power. The system can include a power source configured to provide electrical power. The system can include a controller structured to be coupled with the power source. The controller can convert the electrical power to a first plurality of signals. The system can include an inverter structured to be coupled with the controller. The inverter can include a plurality of legs to receive a second plurality of signals. The system can include a plurality of component controls in the controller. Each of the plurality of component controls can be structured to be coupled with the inverter. At least one component control of the plurality of component controls can detect a ripple within a frequency band of a first signal of the first plurality of signals. The at least one component control can apply, in accordance with a gain function defined for the at least one component control, an adjustment value to suppress the ripple within the frequency band. The at least one component control can provide the first signal as a corresponding signal in the second plurality of signals for the plurality of legs of the inverter.

In some embodiments, the at least one component control can apply, in accordance with the gain function, a second adjustment value to increase a portion of the signal within a second frequency band. In some embodiments, the at least one component control can select, based on a component of a plurality of components defined for the at least one component control, the frequency band of a plurality of frequency bands within which to monitor for the ripple.

In some embodiments, the system can include a signal balancer to convert the first plurality of signals in a first domain to the second plurality of signals in a second domain with the addition of at least one reference signal for a reference leg of the plurality of legs of the converter. In some embodiments, the at least one component control can be structured to be electrically coupled in parallel with at least one component in the controller relative to the inverter.

In some embodiments, the controller can adjust the first plurality of signals in accordance with a proportional-integral (PI) control function. In some embodiments, the power source can include at least one of a generator set, a battery pack, a solar panel, a power plant, or a renewable fuel source.

At least one aspect is directed to a method of regulating generator spatial harmonics. One or more processors can receive a plurality of signals to be provided to a plurality of legs of an inverter. The one or more processors can detect a generator spatial harmonic inside a frequency band for a signal of the plurality of signals. The one or more processors can modify, responsive to detecting the generator spatial harmonic, the signal using a resonant filter to suppress the generator spatial harmonic. The one or more processors can provide the modified signal to a leg of the plurality of legs of the inverter.

In some embodiments, the one or more processors can identify, from a plurality of components corresponding to the plurality of signals, a component corresponding to the signal. In some embodiments, the one or more processors can add, to the second plurality of signals, a reference signal for a corresponding leg of the plurality of legs.

In some embodiments, the one or more processors can adjust the plurality of signals with the modified signal using a proportional-integral (PI) control function. In some embodiments, the one or more processors can receive the plurality of signals from a power source comprising at least one of a generator set, a battery pack, a solar panel, a power plant, or a renewable fuel source. In some embodiments, the one or more processors can increase, using the resonant gain, a portion of the signal within a second frequency band.

It is to be understood that both the foregoing general description and the following detailed description are exemplary and explanatory only and are not restrictive of the present teachings.

### BRIEF DESCRIPTION OF THE DRAWINGS

The disclosure will become more fully understood from the following detailed description, taken in conjunction with the accompanying figures, wherein like reference numerals refer to like elements unless otherwise indicated, in which:

FIG. 1 depicts a block diagram of a system for providing electrical power with handling of harmonics due to unbalanced loads or generator spatial harmonics in accordance with an illustrative embodiment;

FIGS. 2A and 2B depict a circuit diagram of a power subsystem with inverter control for suppressing harmonics in accordance with an illustrative embodiment;

FIG. 3 depicts a circuit diagram of a controller in a power subsystem in accordance with an illustrative embodiment;

FIG. 4 depicts a block diagram of a voltage control in a controller of a power subsystem in accordance with an illustrative embodiment;

FIG. 5 depicts a graph of output voltages and currents in response to coupling with an unbalanced load with the harmonic suppression control active in accordance with an illustrative embodiment; and

FIG. 6 depicts a flow diagram of a method of regulating unbalanced harmonics, in accordance with an illustrative embodiment.

### DETAILED DESCRIPTION

Following below are more detailed descriptions of various concepts related to, and implementations of, systems, methods, apparatuses, and devices for handling unbalanced loads for power sources. The various concepts introduced above and discussed in greater detail below can be implemented in any of a number of ways, as the described concepts are not limited to any particular manner of implementation. Examples of specific implementations and applications are provided primarily for illustrative purposes.

A power subsystem can convey electrical power between a power source (e.g., a battery pack, generator set, a renewable power plant, or mixed fuel power source) and one or more loads or components electrically coupled with the power source. To regulate and facilitate the conveyance of the electrical power, the power subsystem can include a controller and an inverter electrically coupled between the power source and the loads. The power inverter can perform direct current (DC) to alternating current (AC) (also known as DC/AC) conversion (or AC/AC, DC/DC, or AC/DC conversions) on the electrical power between the power source and the load. The controller can modify various characteristics of the electrical power conveyed through the power inverter, such as an amplitude, frequency, or phase, among others. The controller can also configure various functionalities of the power inverter in performing the conversion.

In certain architectures for the power subsystem, the controller can control the inverter using cascaded control loops in a synchronous reference frame or domain. The architecture can include an inner inverter, and an outer load voltage controller, among other components. The controller can use a proportional-integral (PI) control loop structure, with a second order filter (e.g., including a lead and a lag component) on a front end of the loop. This filter can be used to improve stability of combined, potentially resonant components (e.g., filter) and load-side impedances.

Under unbalanced loads, however, this control structure can be insufficient to maintain the AC output voltages at acceptable levels within specifications. In addition, the unbalanced zero-sequence current can be reflected into synchronous direct-quadrature-zero (dq0) domain DC signals as additional frequencies. A ripple (e.g., at 120 Hz) can also be introduced on the d and q components, and another ripple (e.g., at 60 Hz) can also be introduced on the zero component of the AC load voltage. This structure can lead to a loss of performance due to the lags induced by the ripples. Approaches to address these problems can come short. For example, a single PI controller may be used to maintain voltages, but with a high proportional gain (Kₚ) over the entire frequency range, may be unable to fully resolve the issue of harmonics resulting from imbalanced operations. In another example, a large capacitor may be used to trim voltages, but the capacitor may not provide a fast response and may take a large volume of space in the controller.

To address these and other technical challenges, a voltage control in the controller can be configured with a Proportional-Resonant (PR) control loop structure to suppress ripples in the AC load voltage. For instance, the PR control loop structure can be used to suppress 120 Hz ripple on the d and q components and 60 Hz ripple on the zero component. The suppression can be carried out by increasing the dq0 loop gains at the targeted frequencies, thereby lowering the steady state control loop error. The PR controller can also target voltage waveform harmonics in the d and q components. For example, when coupled with a generator set (also referred to herein as a genset), the controller can target the fifth and seventh harmonics of the generator spatial winding harmonics. These harmonics can be at a different frequency in the d and q domains and a band pass filter (BPF) can be used to target these different frequencies. The targeting of multiple harmonics can be performed using multiple controllers in parallel.

This control loop structure can include a resonant control component to target ripple frequencies. Since the component is in parallel with other components, the resonant control component can be treated as if the component were an isolated element. This can result in balanced AC voltages within specification for unbalanced loads (e.g., as maximum single phase line-neutral (LN) load), not affecting the performance during balanced load condition. In addition, the control loop structure can include a band pass filter (BPF) integrated into a PI control loop structure. The resonant gain (Kᵣ), the frequency passband (ω_{C}), and the center frequency (ω₀) parameters can be tuned to strengthen or weaken the PR controller and control the frequency range at which the PR controller is active. To disable the PR portion of the controller, the resonant gain can be set to null upon configuration.

Furthermore, the controller can perform transformation between the dq0 rotating reference domain and three phase ABC time domains, with the inclusion of a neutral component. For instance, the 3×3 abc to dq0 and dq0 to abc transformations can be updated to include a neutral component to leverage the fourth leg of the power inverter. For the four-legged inverter, the neutral input to the voltage transform can be set to a defined value (e.g., 0) or to some measured value acquired via a voltage sensor. This additional or derived measurement can draw an equivalent between the load and the inverter modulation mid-value reference point. The neutral input to the current transform can be the measured neutral current.

In this manner, the PR controller can target any irregular or non-linear load that has harmonics reflected into the voltage components (e.g., dq0 or abc domains) to maintain AC voltages within a specified range. The controller can have a control loop (e.g., proportional-integral (PI) control) integrated with a filter (e.g., a proportional-resonant band pass filter). This augmentation of the controller can be used to amplify desired frequency bands and suppress other bands associated with unbalanced harmonics, without entailing a large form factor in the controller or high processing loads. By suppressing harmonics arising from unbalanced operations, the controller can provide a stable AC voltage and power to components electrically coupled with the controller.

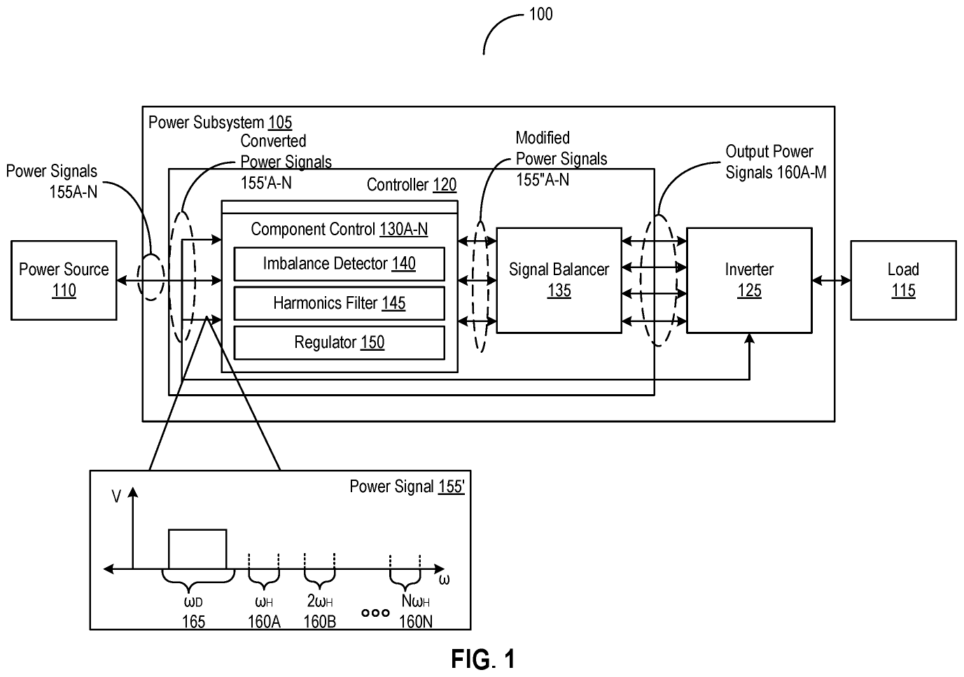

FIG. 1 depicts a block diagram of a system 100 for providing electrical power with handling of harmonics due to unbalanced loads or generator spatial harmonics. In brief overview, the system 100 can include at least one power subsystem 105, at least one power source 110, and at least one load 115, among others. The power subsystem 105 can be structured to be electrically coupled with the power source 110 and the load 115. The power subsystem 105 can include at least one controller 120 and at least one inverter 125, among others. The controller 120 can include a set of component controls 130A-N (hereinafter generally referred to as component controls 130), among others. In some embodiments, the controller 120 can include at least one signal balancer 135 (sometimes herein referred to as a domain transformer). Each component control 130 can include at least one imbalance detector 140, at least one harmonics filter 145, and at least one regulator 150, among others.

Components of the power subsystem 105, such as the controller 120, can be implemented using circuitry. The circuitry can include logic or machine-readable instructions to define the behavior, functions, and operations of the controller 120. The circuitry can be implemented by computer readable media which can include code written in any programming language, including, but not limited to, Java, JavaScript, Python or the like and any conventional procedural programming languages, such as the “C” programming language or similar programming languages. The machine-readable instructions can be stored and maintained on memory. The circuitry can include one or more processors to execute the machine-readable instructions. The one or more processors can be coupled with the memory to execute the machine-readable instructions therefrom.

The processors in the power subsystem 105 can communicate with one or more remote processors. The remote processors can be connected to each other through any type of network (e.g., a CAN bus, etc.). The memory (e.g., RAM, ROM, Flash Memory, hard disk storage, etc.) can be a computer-readable medium to store data or computer code for facilitating the various processes described herein. The memory can be communicably connected to the processing circuitry to provide computer code or instructions for executing at least some of the processes described herein. The memory can be or include tangible, non-transient volatile memory or non-volatile memory and can include database components, object code components, script components, or any other type of information structure for supporting the various activities and information structures described herein.

The power source 110 can generate, output, or otherwise provide electrical power. The power source 110 can include or correspond to any source of the electrical power for the system 100. The power source 110 can include, for example, a battery pack (e.g., a collection of batteries to store electrical charge), a generator set (e.g., a generator with an engine to produce electrical power), a microgrid (e.g., a localized system of one or more power sources or loads to operate independently or in conjunction with a power grid), a renewable fuel power source (e.g., a photovoltaic array, a generator coupled with hydraulic turbine, or a wind power generator), a modular reactor (e.g., a nuclear reactor to convert nuclear fuel into energy), a power station (e.g., a facility to generate electrical power), or a power interface coupled with an external power component, among others. The power source 110 can be structured to be electrically coupled with the power subsystem 105 (e.g., via a bus or connector). The power source 110 can be electrically coupled with the power subsystem 105 to convey, send, or otherwise deliver the electrical power through the power subsystem 105. The power source 110 can be electrically coupled with the components within power subsystem 105, such as the controller 120 and the inverter 125. In the depicted example, the power source 110 can convey the electrical power through the inverter 125 under the control of the controller 120 in the power subsystem 105. The power source 110 can be electrically coupled with both the controller 120 and the inverter 125, with the controller 120 sending the power condition of the power source 110 and controlling power through the inverter 125.

The electrical power provided by the power source 110 to the power subsystem 105 (or another electrically coupled component) can be a direct current (DC) power or an alternating current (AC) power. For example, the power source 110 can also be a wind power generator to produce DC power to provide the power subsystem 105. The power source 110 can be a generator set to produce AC power to provide the power subsystem 105. In some embodiments, the power source 110 can be part of the same apparatus, device, or component as the power subsystem 105. In some embodiments, the power source 110 can be separate from the power subsystem 105. For example, the power subsystem 105 can be physically separate from the power source 110 and be electrically coupled with the power source 110 via an electrical bus connection.

The power subsystem 105 can be structured to be coupled with the power source 110 and the load 115. The power subsystem 105 can be electrically coupled with the power source 110 or the load 115 in series (e.g., in between as depicted), in parallel, or in any combination thereof. The power subsystem 105 can convey or pass the electrical power between the power source 110 and the load 115. When the power source 110 is discharging to the load 115, the power subsystem 105 can accept, obtain, or otherwise receive the electrical power drawn from the power source 110. Conversely, when charging from one of the components (e.g., via the load 115), the power subsystem 105 can accept, obtain, or otherwise receive the electrical power from the external source to be directed to charge a power storage (e.g., batteries of the power source 110).

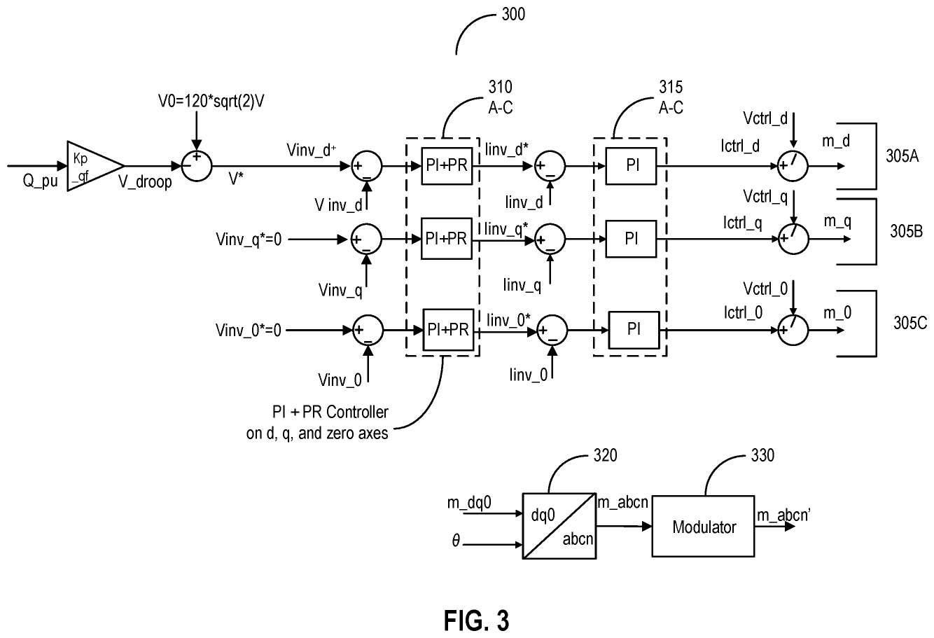

In the power subsystem 105, the controller 120 (sometimes herein referred to as a grid supporting control, gate control, source control, control device, device, or control) can regulate, manage, or otherwise control voltage and current of the electrical power conveyed through the power subsystem 105. The controller 120 can be structured to be coupled with the power source 110 and the inverter 125 and control the passage or conveyance of the electrical power from the power source 110 through the inverter 125, such as control of the voltage, current, power factor unbalanced phase loads, and harmonics, among others. The controller 120 can measure, instrument, or otherwise sense the electrical power (e.g., voltage, current, and harmonics), and control the power flow through the inverter 125 by dampening harmonics and unbalanced loads. The electrical power can correspond to or have a set of components (e.g., voltage or current components) in a domain. For example, the electrical power can be defined in terms of a direct (D) component, quadrature (Q) component, and zero (0 or Z) component in the dq0 domain, or A-phase, B-phase, and C-phase in the abc time domain, among others. The electrical power can have been transformed from another domain by another module in the power subsystem 105. The detail of an example architecture for the controller 120 is described herein in conjunction with FIG. 3.

From the electrical power, the controller 120 can retrieve, receive, or otherwise identify a set of power signals 155A-N (hereinafter generally referred to as power signals 155) from the power source 110. The power signals 155 may be in an initial domain (e.g., abc domain). In some embodiments, the controller 120 can translate, transform, or otherwise convert the electrical power signal into the set of power signals 155 (e.g., using DC to AC conversion). The set of power signals 155 can be directed, destined, or otherwise to be provided to a corresponding set of legs in the inverter 125. For instance, the first power signal 155A can correspond to a first leg in the inverter 125, the second power signal 155B can correspond to a second leg in the inverter 125, and the third power signal 155C can correspond to a third leg in the inverter 125. In some embodiments, the set of power signals 155 can initially number less than the number of legs of the inverter 125. For example, at least one of the legs of the inverter 125 can be a neutral or reference leg, and none of the set of power signals 155 can correspond to the reference leg of the inverter 125. The set of power signals 155 may undergo dampening harmonics and unbalanced loads through the the controller 120, as detailed herein.

With the identification, the controller 120 can convert or transmit the set of power signals 155 from the original domain to another domain (e.g., from abc to vector-based dq0 domain) to generate a set of converted power signals 155′. Each power signal 155′ can correspond to a respective component of the domain (e.g., in the dq0 domain). For example, the first power signal 155′A can correspond to a direct component, the second power signal 155B can correspond to a quadrature component, and the third power signal 155′C can correspond to a zero component in the dq0 domain. In some embodiments, at least one of the components can be set to a defined value. For example, the power signals 155′ corresponding to the quadrature and zero components can be initially set to zero.

With the identifications of the unbalanced load, the controller 120 can convey, pass, or otherwise provide the set of power signals 155′ to the corresponding set of component controls 130 (e.g., in the vector-based dq0 domain). The set of component controls 130 can correspond to the set of components in the domain. For instance, the first component control 130A can correspond to a direct component, and the controller 120 can provide the first power signal 155′A corresponding to the direct component to the first component control 130A. The second component control 130B can correspond to a quadrature component, and the controller 120 can provide the second power signal 155′B corresponding to the quadrature component to the second component control 130B. The third component control 130C can correspond to a zero component in the DQ0 domain, and the controller 120 can provide the third power signal 155′C corresponding to the zero component to the third component control 130C.

Each component control 130 executing on the controller 120 can regulate, manage, or otherwise control voltage and current of the power signal 155′ in the respective component of the domain (e.g., in one of the dq0 components). In some embodiments, the component control 130 can be structured to be coupled with the power source 110 and the inverter 125 via another component of the controller 120 (e.g., the signal balancer 135). The component control 130 can pass or convey the received power signal 155′ corresponding to one of the components in the domain.

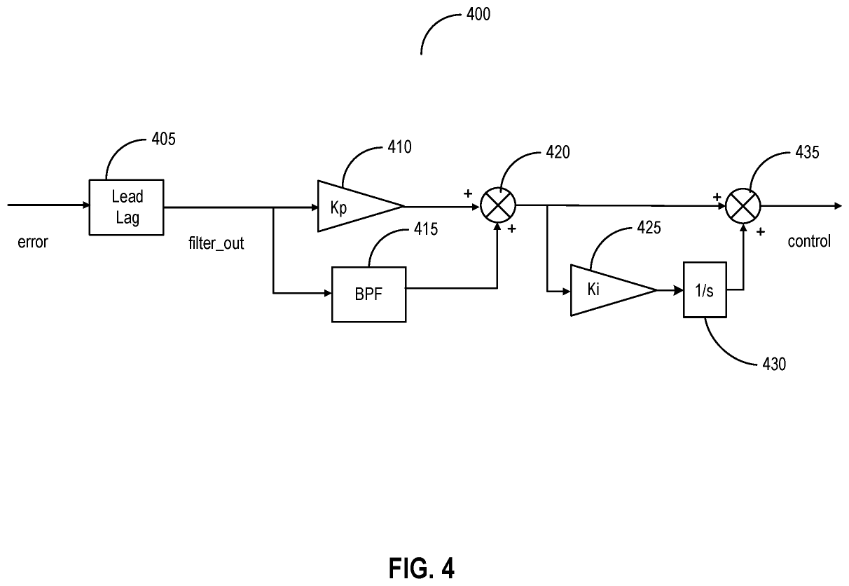

The component control 130 can control the voltage and current component using the imbalance detector 140, the harmonics filter 145 (sometimes herein referred to as a resonant filter), and the regulator 150, among others. The imbalance detector 140, the harmonic filter 145, and the regulator 150 in one component control 130 can coordinate with the imbalance detector 140, the harmonic filter 145, and the regulator 150 in another component control 130 to perform dampening of harmonics and unbalanced loads. In some embodiments, the imbalance detector 140 and the harmonics filter 145 can form a proportional-resonant (PR) controller in parallel with a proportion-integral (PI) controller provided by the regulator 150. The architecture of the component control 130 is detailed herein in conjunction with FIG. 4. It is noted that resonant harmonics filtering can also occur in the time domain to the power signal 155′ before conversion to the dq0 frequency domain.

In some embodiments, the controller 120 may perform filtering (e.g., harmonics dampening) to the set of power signals 155. The filtering may be performed prior to the transformation of the set of power signals 155 from the initial domain, or independent of the generation of the converted set of power signals 155′. For example, the controller 120 may perform resonant harmonics filtering on the power signals 155 in the time-domain using a time-domain filter, such as a linear filter, a Kalman filter, or a Savizky-Golay filter, among others.

Within each component control 130, the imbalance detector 140 can find, scan, or otherwise monitor for an unbalanced load for the power signal 155′ received at the component control 130. The power signal 155′ can correspond to one of the components in the domain (e.g., dq0 or abc domain). To monitor for an unbalanced load, the imbalance detector 140 can translate, convert, or otherwise transform the voltage component of the power signal 155′ from a time-domain to a frequency domain. The unbalanced load can correspond to a spatial harmonic, a ripple, or other artifact within a set of harmonic frequency bands (ω_{H}, 2ω_{H}, . . . . Nω_{H},) reflected to control domain 160A-N (hereinafter referred to as harmonic frequency bands 160, sometimes herein referred to as an undesired frequency band) within the voltage component of the power signal 155′. The second and higher harmonic frequency bands 160B-N can be multiples (e.g., 2, 3, . . . . N) of the first frequency band 160A. In some embodiments, the imbalance detector 140 can find, scan, or monitor for a generator spatial harmonic in the power signal 155′. The generator spatial harmonic may correspond to a ripple or artifact within one of the harmonic frequency bands 160 generated by the power source 150. Conversely, the desired frequency band can correspond to a portion of the power signal 155′ in at least one desired frequency band (wp) 165 (sometimes herein referred to as a non-harmonic frequency band or target frequency band).

In some embodiments, the imbalance detector 140 can determine, identify, or otherwise select the harmonic frequency band 160 (e.g., the first harmonic frequency band 160A) within which to identify the unbalanced load. The harmonic frequency band 160 can be selected from a set of candidate frequency bands within which the harmonic is expected to reside. The harmonic frequency band 160 can correspond to a portion of the frequency domain representation of the voltage of the power signal 155′ within which the harmonic, ripple, or other undesired artifact is to be suppressed. The selection of the harmonic frequency band 160 can be based on the component within the domain corresponding to the power signal 155′. For example, for power signals 155′ in the direct (D) and quadrature (Q) domains, the harmonic frequency band 160 can be selected to be about 120 Hz with a passband of +/−10 Hz. In addition, for the power signal 155′ in the zero domain, the harmonic frequency band 160 can be selected about 60 Hz, with a passband of +/−10 Hz. The harmonic frequency band 160 can be defined as about a central frequency and a cut off frequency relative to the central frequency. In some embodiments, the imbalance detector 140 can determine multiple undesired frequency bands 160. For instance, the center frequencies of the undesired frequency bands 160 can be multiples of a harmonic, such as 120 Hz, 240 Hz, 360 Hz, and so forth, or the appropriately reference frame reflected harmonic. The harmonic frequency band 160 (e.g., at least the first harmonic frequency band 160A) can be predefined by an administrator of the power subsystem 105.

In some embodiments, the imbalance detector 140 can determine, identify, or otherwise select the frequency band 165 outside of which to identify the unbalanced load. The desired frequency band 165 can correspond to a portion of the frequency domain representation of the power signal 155′ to be boosted, increased, or otherwise amplified. In some embodiments, the selection of the desired frequency band 165 can be based on the component within the domain corresponding to the power signal 155′. In some embodiments, the desired frequency band 165 can be selected by the imbalance detector 140 relative to the frequency band 160 within which the portion of the power signal 155′ is to be suppressed. For instance, as depicted, the imbalance detector 140 can select the portion of the frequency domain representation that is less than the lower cut off frequency of the undesired frequency band 165 as the desired frequency band 165. For power signals 155′ in the direct (D) and quadrature (Q) domains, the desired frequency band 165 can be selected to be 110-130 Hz. Furthermore, for the power signal 155′ in the zero domain, the frequency band 165 can be selected to be within 50-70 Hz.

In monitoring for a generator spatial harmonic, the imbalance detector 140 can measure, identify, or otherwise determine an amplitude (e.g., voltage component) within the harmonic frequency band 160. In some embodiments, the imbalance detector 140 can measure, identify, or otherwise determine the amplitude outside the desired frequency band 165. The amplitude can correspond to an extrema value (e.g., a maximum) of the voltage component in the frequency domain representation of the power signal 155′. With the determination of the amplitude, the imbalance detector 140 can compare the amplitude with a threshold. The threshold can delineate, identify, or otherwise define a value for the amplitude at which to detect the unbalanced load within the harmonic frequency band 160. When the amplitude is greater than or equal to the threshold, the imbalance detector 140 can determine, identify, or otherwise detect a presence of the unbalanced load within the harmonic frequency band 160. In some embodiments, the imbalance detector 140 can identify the unbalanced load within the harmonic frequency band 160. Otherwise, when the amplitude is less than the threshold, the imbalance detector 140 can determine, identify, or otherwise detect an absence of the unbalanced load within the harmonic frequency band 160.

The harmonic filter 145 can be configured with a resonant gain function (sometimes herein referred to as a resonant gain or a gain function) to adjust, change, or otherwise modify the power signal 155′. The resonant gain function can specify, identify, or otherwise define a filter to apply to the power signal 155′. The filter for the resonant gain function can be defined in the frequency domain to perform proportion-resonant (PR) control. For instance, the filter of the resonant gain function can be a band pass filter (BPF) to attenuate or suppress the portion of the power signal 155′ outside a defined region within the frequency domain, such as the target frequency band 165. The filter can also boost or amplify the portion of the power signal 155′ within a defined region within the frequency domain, such as the target frequency band 165. The resonant gain function can be predefined by the administrator of the power subsystem 105.

In some embodiments, the harmonic filter 145 can determine, identify, or otherwise select the resonant gain function in accordance with the component corresponding to the power signal 155′ in the domain (e.g., dq0 or abc domain). The resonant gain may be determine at least in partial concurrence with the determination of the harmonic frequency bands 160 or target frequency band 165. The filter for the resonant gain function can be to suppress harmonics, ripples, or other artifacts within the one or more harmonic frequency bands 160, which in turn can be dependent on the component of the domain. The resonant gain function can be selected to attenuate, suppress, or reduce voltages outside desired target frequency band 165. For instance, for power signals 155′ in the direct (D) and quadrature (Q) domains, the resonant gain function can be selected to pass the portion of the power signal 155′ within 20-110 Hz. In addition, for the power signal 155′ in the zero domain, the resonant gain function can be selected to pass the portion of the power signal 155′ within 25-50 Hz.

With the detection of the unbalanced load, the harmonics filter 145 can calculate, generate, or otherwise determine an adjustment value to apply to the power signal 155′ in accordance with the resonant gain function. The adjustment value can correspond to a value of the resonant gain function at a particular frequency or frequency band to be applied to the power signal 155′. Upon determination of the adjustment value, the harmonics filter 145 can apply the adjustment value to the power signal 155′ to change, alter, or otherwise modify the power signal 155′. The adjustment value can be applied to the portion of the power signal 155′ within the harmonic frequency band 160 to reduce, eliminate, or otherwise suppress the unbalanced load, ripple, or other artifact. In some embodiments, the adjustment value can be applied to boost, increase, or otherwise amplify the portion of the power signal 155′ within the target frequency band 165.

By modifying the portion of the power signal 155′, the harmonics filter 145 can generate a modified power signal 155′ to forward, convey, or otherwise provide to the corresponding leg of the set of legs of the inverter 125, via one or more other components in the controller 120. In some embodiments, the harmonics filter 145 can convert, transform, or otherwise transform the power signals 155′ from the converted domain to the original domain. The harmonics filter 145 can determine or identify the domain (e.g., dq0 domain) in which the modified power signals 155′ are defined. The harmonics filter 145 can select or identify a target domain (e.g., abc domain) to which to convert the modified power signals 155′. With the identification of the target domain, the harmonics filter 145 can perform the domain transformation from the original domain to the target domain. In performing the domain transformation, the harmonics filter 145 can calculate, generate, or otherwise determine the value for each component in the set of components in the target domain for the modified power signals 155′. The modified power signals 155′ in the target domain can include a value for each component (e.g., A-phase, B-phase, and C-phase)

In conjunction, in some embodiments, the regulator 150 can manage, handle, or otherwise control the voltage of the power signal 155′ using at least one control loop. The control loop of the regulator 150 can be, for example, a proportional-integral (PI) control loop or a proportional-integral-derivative (PID) control loop, among others. The regulator 150 can apply the control loop to the voltage component of the power signal 155′ to change, alter, or otherwise modify the voltage component. The control loop of the regulator 150 can process the power signal 155′ in parallel to the harmonic filter 145 and the imbalance detector 140. For example, the regulator 150 can apply the PI control loop to the voltage component of the power signal 155′, parallel to the adjustment value determined from the resonant gain filter of the harmonics filter 145. The application of the control loop can be parallel to the proportional-resonant (PR) control provided by the harmonics filter 145 and the imbalance detector 140. For example, the application of the PI control loop to regulate the voltage of the power signal 155′ may be parallel to the adjustment value applied to the voltage of the power signal 155′.

In some embodiments, the regulator 150 can manage, handle, or otherwise control the current of the power signal 155′ using at least one control loop. The control loop of the regulator 150 can be, for example, a proportional-integral (PI) control loop or a proportional-integral-derivative (PID) control loop, among others. The regulator 150 can apply the control loop to the current component of the power signal 155′ to change, alter, or otherwise modify the current component. The regulator 150 can process the current component, in series with the harmonics filter 145 and the imbalance detector 140. For instance, the regulator 150 can apply the PI control loop to the current component of the power signal 155′, subsequent to the modification of the voltage component. With the modification of the voltage component, the regulator 150 can convey, forward, or otherwise provide the power signal 155′ to the inverter 125, via the one or more components of the controller 120.

In some embodiments, the signal balancer 135 executing on the controller 120 can retrieve, identify, or otherwise receive a set of modified power signals 155″A-N (hereinafter generally referred to as modified power signals 155″). The signal balancer 135 can be structured to be coupled with the set of component controls 130 to retrieve, identify, or otherwise receive the respective modified power signals 155″. The set of modified power signals 155″ can correspond to the set of power signals 155 adjusted in accordance with the control loop (e.g., PI control) provided by the regulator 150 and PR control provided by the imbalance detector 140 and the harmonics filter 145. Each power signal 155″ can correspond to a respective component of the domain. For example, the first power signal 155″A can correspond to a direct component, the second power signal 155″B can correspond to a quadrature component, and the third power signal 155″C can correspond to a zero component in the DQ0 domain.

In some embodiments, the signal balancer 135 can convert, transform, or otherwise transform the modified power signals 155″ from one domain to another domain. For example, when received from the component controls 130, the modified power signals 155″ can be the dq0 domain. Upon receipt of the modified power signals 155″, the signal balancer 135 can determine or identify the domain (e.g., dq0 domain) in which the modified power signals 155″ are defined. The signal balancer 135 can select or identify a target domain (e.g., abc domain) to which to convert the modified power signals 155″. With the identification of the target domain, the signal balancer 135 can perform the domain transformation from the original domain to the target domain. In performing the domain transformation, the signal balancer 135 can calculate, generate, or otherwise determine the value for each component in the set of components in the target domain for the modified power signals 155″. The modified power signals 155″ in the target domain can include a value for each component (e.g., A-phase, B-phase, and C-phase). In some embodiments, the signal balancer 135 can omit the transformation of the set of modified power signals 155″, and the transformation may been performed on the harmonics filter 1445.

In some embodiments, the signal balancer 135 can identify or determine whether any of the power signals 155″ correspond to a reference signal (sometimes herein referred to as a neutral signal). The reference signal can correspond to the at least one of the power signals 155″ against which the remaining signals 155″ are to be balanced, shifted, or adjusted. The reference signal can be provided to a corresponding leg of the inverter 125, while the remaining power signals 155″ can correspond to the remaining legs of the inverter 125. For example, the set of power signals 155″ can include signals corresponding to A-phase, B-phase, and C-phase components, and can be provided to the set of legs corresponding to the A-phase, B-phase, and C-phase components in the ABC domain.

To determine whether any of the power signals 155″ corresponds to the reference signal, the signal balancer 135 can count, identify, or otherwise determine the number of signals in the set of power signals 155″. With the determination of the number of signals, the signal balancer 135 can compare the number of signals against the number of expected components for the identified domain (e.g., ABC domain). If the number of signals is greater than the number of expected components, the signal balancer 135 can determine that at least one of the power signals 155″ correspond to the reference signal. On the other hand, if the number of signals equals to the number of expected components, the signal balancer 135 can determine that none of the power signals 155″ correspond to the reference signal. When none of the power signals 155″ are determined to correspond to the reference signal, the signal balancer 135 can produce or generate the reference signal to add to the set of power signals 155″. The reference signal can be assigned or set to a defined value (e.g., null). With the generation of the reference signal, the signal balancer 135 can join, combine, or otherwise add the reference signal to the set of power signals 155″.

In some embodiments, the signal balancer 135 can forward, pass, or otherwise provide the set of power signals 155″ with the reference signal as a set of output power signals 160A-M (hereinafter generally referred to as output power signals 160, sometimes referred to herein as gating signals) to the inverter 125. In some embodiments, the signal balancer 135 can carry out, execute, or perform modulation on the set of modified power signals 155′ to generate the corresponding set of power signals 160A-M. Each power signal 160 can be a pulse width modulated (PWM) signal to be provided to a corresponding leg of the inverter 125 and can be used to direct or control the DC/AC conversion of the electric power conveyed through the inverter 125. For instance, the first power signal 160A can correspond to a first leg in the inverter 125, the second power signal 160B can correspond to a second leg in the inverter 125, and the third power signal 160C can correspond to a third leg in the inverter 125.

In some embodiments, the signal balancer 135 can convert, transform, or otherwise translate the set of components (e.g., A-phase, B-phase, and C-phase) in the modified power signals 155′ (with the addition of the reference signal) to the set of PWM signals corresponding to the power signals 160. In some embodiments, the signal balancer 135 can perform a rebalancing of the set of modified power signals 155″.

In some embodiments, the signal balancer 135 can forward, convey, or otherwise provide the set of output power signals 160 to the corresponding set of legs in the inverter 125. For example, the signal balancer 135 can provide the output power signal 160A corresponding to the A-phase component to the leg of the inverter 125, also corresponding to the A-phase component in the ABC domain. The signal balancer 135 can provide the output power signal 160B corresponding to the B-phase component to the leg of the inverter 125, also corresponding to the B-phase component in the ABC domain. The signal balancer 135 can provide the output power signal 160C corresponding to the C-phase component to the leg of the inverter 125, also corresponding to the C-phase component in the ABC domain. The signal balancer 135 can provide the output power signal 160D corresponding to the reference signal to the neutral or reference leg of the inverter 125.

The inverter 125 (sometimes herein referred to as a power inverter or rectifier) can convey the electrical power between the power source 110 and the load 115. The inverter 125 can be structured to be coupled with the power source 110 and the load 115. The inverter 125 can also be structured to be coupled with the controller 120 in the power subsystem 105. The inverter 125 can obtain, accept, or otherwise receive the set of output power signals 160. The inverter 125 can include a set of legs to receive the corresponding set of output power signals 160. The inverter 125 can be structured coupled with the signal balancer 135 to receive the set of output power signals 160. Each leg of the inverter 125 can correspond to a phase of the AC electrical power to be delivered. For example, the inverter 125 can include four legs, three for A-phase, B-phase, and C-phase, and the remaining fourth for the reference signal. Although described having three-legs, in various embodiments, the inverter 125 can have any number of legs.

Using the set of output power signals 160, the inverter 125 can transform or convert the electrical power from AC to DC (e.g., using an active rectifier). In some embodiments, the inverter 125 can transform the electrical power from DC to AC. As discussed above, the electrical power can be passed through the power subsystem 105 in either direction. The inverter 125 can be electrically coupled between the power source 110 and the load 115 in series configuration (e.g., as depicted) or in parallel, or in any combination thereof. The inverter 125 can include one or more components, such as an inverter and rectifier, or any combination thereof, to perform the DC to AC conversion. In some embodiments, the inverter 125 can feed forward or provide the AC electrical power corresponding to the set of output power signals 160 to the load 115.

Upon transformation of the electrical power from DC to AC, the inverter 125 can convey, send, or otherwise provide the electrical power (e.g., in the form of AC) to the load 115. The load 115 electrically coupled with the power subsystem 105 can include or correspond to any component electrically coupled with the power subsystem 105 to use, spend, or otherwise consume the electrical power originating from the power subsystem 105. The load 115 can include, for example, analog electronics, computer devices, and electric vehicles, among others. In some embodiments, the inverter 125 can exchange or convey the electrical power with other components coupled with the power subsystem 105.

While the features are described as being performed by individual sub-components (e.g., the controller 120, the component controls 130 and its subcomponents, and the signal balancer 135, among others), in various implementations the features can be performed by the processor and can be implemented via one or more of the other elements of memory or different elements. For example, the processor of the controller 120 (or the power subsystem 105) can execute instructions defining the individual component controls 130, including the imbalance detector 140, the harmonics filter 145, the regulator 150, and the signal balancer 135 of the controller 120, among others, as stored and maintained on the memory.

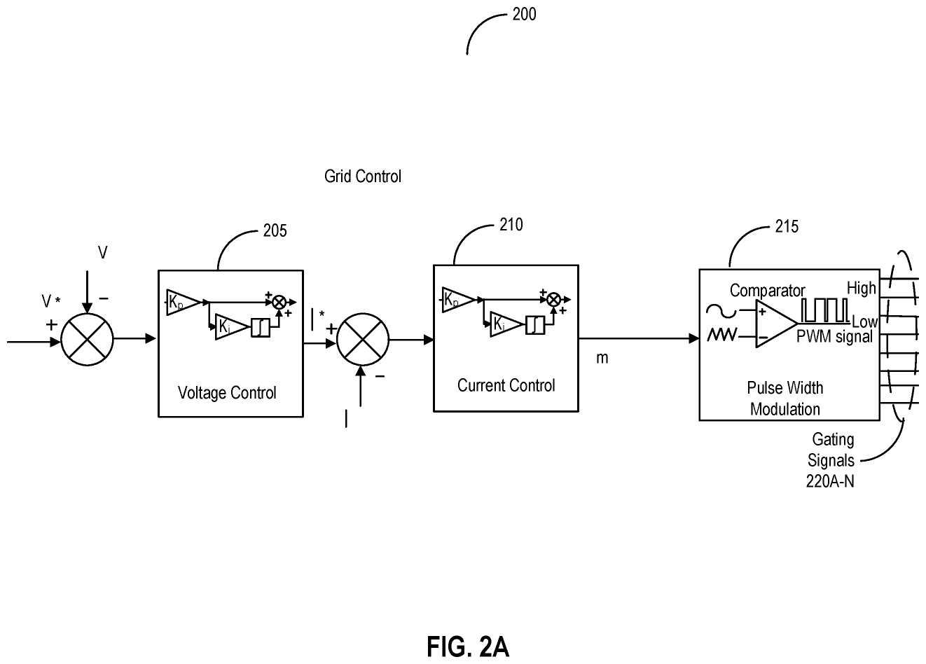

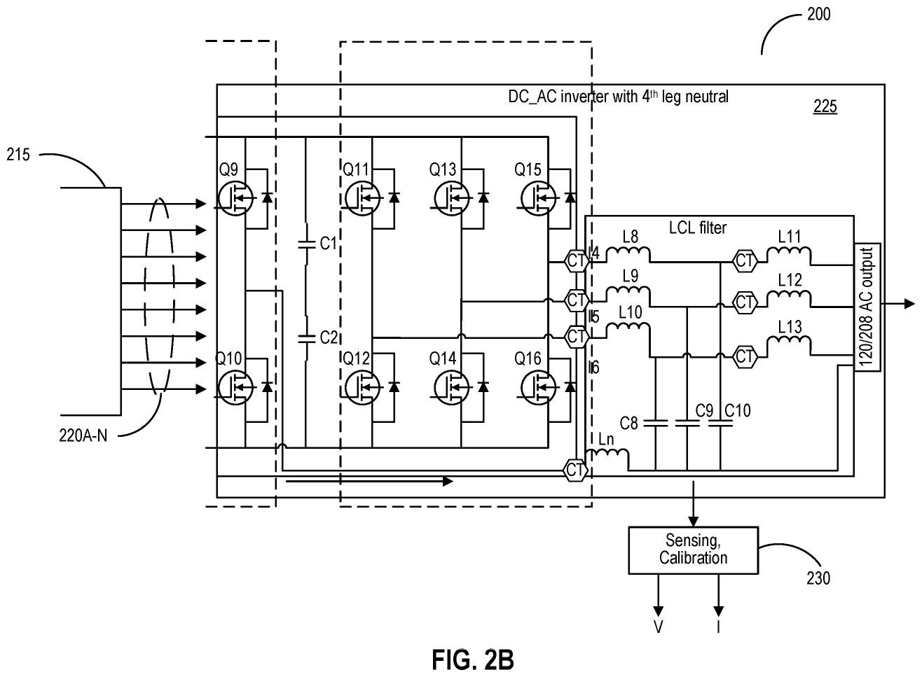

Referring now to FIGS. 2A and 2B, among others, depicted is a circuit diagram of a power subsystem 200 with inverter control for suppressing harmonics. The power subsystem 200 can be part of or can include one or more of the components in the system 100. The power subsystem 200 can include one or more components to receive direct current (DC) electrical power from a power source for conversion into alternating current (AC) electrical power to provide to components electrically coupled with the power system 200.

Starting with FIG. 2A, the power subsystem 200 can include at least one voltage control 205 and at least one current control 210, among others. The voltage control 205 can accept, obtain, or otherwise receive an electrical power via a voltage summer (e.g., summation with a configured input). The electrical power can be defined in terms of one domain (e.g., DQ0 domain). The voltage control 205 can regulate the voltage of the electrical power in accordance with a PI control function. In addition, the voltage control 205 can regulate the voltage with a proportional resonant (PR) control function and a band pass filter (BPF) to suppress any harmonics, ripples, or undesired artifacts in certain frequency bands.

The voltage control 205 can feed an output set of power signals forward to the current summer to modify (e.g., summation with a configured input) the current. The current control 210 can accept, obtain, or otherwise receive the output from the voltage control 205 via the current summer. The current control 210 can further regulate the current of the electrical power in accordance with a PI control function. By regulating the current, the current control 210 can produce, output, or otherwise generate as output a modified set of power signals to feed forward.

In addition, the power subsystem 200 can include at least one pulse width modulation unit 215. The pulse width modulation unit 215 can accept, obtain, or otherwise receive the output from the voltage control PI loop 205 and the current control PI loop 210. The pulse width modulation unit 215 can convert the power signal from one domain (e.g., dq0 domain) to a target domain (e.g., A-phase, B-phase, and C-phase time domain). Using the power signals, the pulse width modulation unit 215 can produce, output, or otherwise generate a set of gating signals 220A-N (hereinafter generally referred to as a set of gating signals 220). In generating the gating signals 220, the pulse width modulation unit 215 can add a reference signal and apply a modulation across the input set of power signals in accordance with a set duty cycle.

Moving onto FIG. 2B, the pulse width modulation unit 215 can feed or provide the set of gating signals 220 to a set of corresponding inputs or legs of an inverter 225. The power subsystem 200 can include at least one inverter 225 to perform conversion (e.g., DC/AC, AC/AC, AC/DC, and DC/DC) on the gating signals 220 from the pulse width modulation unit 215. The inverter 225 can include a set of switch banks and at least one filter. The set of switch banks can correspond to the set of legs or inputs for the inverter 225. The inverter 225 can also perform additional filtering using inductance-capacitance (e.g., LCL filters) filters to suppress harmonics in the current component of the output electrical power.

With the conversion of the set of gating signals 220, the inverter 225 can provide or output the electrical power to a component coupled with the power subsystem 200. The power system 200 can include at least one sensing and calibration unit 230. The sensing and calibration unit 230 can provide instrumentation on the voltage and current of the electrical power output from the inverter 225. The measurements from the sensing and calibration unit 230 can be fed back to the voltage control 205 and the current control 210 to as the output current and voltage representation to adjust the power signal for output.

Referring now to FIG. 3, among others, depicted is a circuit diagram of a controller 300 in the power subsystem. The control 300 can be part of or can include components in the system 100 or the power subsystem 200. The control 300 can include one or more components to control the flow of electrical power from a power source to a load through an inverter. The control 300 can include a set of component controls 305A-C (hereinafter generally referred to as component controls 305). Each component control 305 can correspond to a respective component in a domain. In the depicted example, the first component control 305A can correspond to a direct (D) component, the second component control 305B can correspond to a quadrature (Q) component, and the third component control 305C can correspond to a zero (0) component in the dq0 domain.

The set of component controls 305 can output or generate a corresponding set of modulation signals (m_d, m_q, and m_0) using an input set of power signals in the domain. The input set of power signals can correspond to a reactive power component (Q_pu) of the electrical power conveyed between a power source and a load. At least one of the component controls 305 (e.g., the first component control 305A as depicted) can accept, obtain, or otherwise receive the reactive power component of the electrical power. The reactive power component can have at least one voltage component (Vinv_d*) in the domain provided to the first component control 305A. The voltage component can be modified by measured output voltage component (Vinv_d). Other component controls 305 (e.g., the second component 305B and the third component control 305C) can accept, obtain, or otherwise receive the reactive power component of the electrical power set to a defined value. In the depicted example, the defined value for the constituent voltage component can be zero (e.g., Vinv_q*=0 and Vinv_0*=0). The voltage components can be modified by measured output voltage component (Vinv_q and Vinv_0).

The set of component controls 305 can have a corresponding set of voltage controls 310A-C (hereinafter generally referred to as voltage controls 310). Each voltage control 310 can have a proportional-integral (PI) control and a proportional-resonant (PR) control. In each voltage control 310, the PI control can adjust the voltage component in accordance with gain factor defined by the PI function. The PR control can suppress harmonics (and any multiple thereof) in the input voltage component and can amplify a portion of the voltage component corresponding to a target frequency band in accordance with a gain factor defined by the PR control function. Each voltage control 310 can feed forward the modified voltage component along the respective component control 305.

The set of component controls 305 can also have a corresponding set of current controls 315A-C (hereinafter generally referred to as current controls 315). Each current control 315 can have a proportional-integral (PI) control to adjust or modify the input current component in accordance with a gain factor defined in accordance with the PI function. Each current control 315 can receive the modified power component (e.g., corresponding to Iinv_d*, Iinv_q*, and Iinv_0*) from the corresponding voltage control 310 in the respective component control 305. In the depicted example, the defined value for the constituent current component can be modified by measured output current component (Iinv_d, Iinv_q, and Iinv_0). The current control 315 can feed forward the modified voltage component along the respective component control 305. Using the outputs of the set of current controls 315 along with a set of control signals (e.g., Vctrl_d, Vctrl_q, Vctrl_0), the set of component controls 305 can output the set of power signals (m_d, m_q, and m_0).

In addition, the control 300 can include at least one domain transformer 320 and at least one modulator 330. The domain transformer 320 can convert the set of power signals output from the corresponding set of component controls 305 from one domain (e.g., dq0 domain) to a target domain (e.g., abc domain). In addition, the domain transformer 320 can add a reference signal (“n”) to the set of power signals. With the addition of the reference signal, the domain transformer 320 can generate and output a set of translated power signals (m_abcn) to feed forward along the control 300 to the modulator 330. Using the set of translated power signals, the modulator 330 can produce, output, or otherwise generate a set of modulated signals (m_abcn′). The modulator 330 can also perform balancing across the set of power signals across the constituent components (e.g., abcn). With the generation of the set of modulated signals, the modulator 330 can provide the set of modulated power signals to the inverter.

Referring now to FIG. 4, among others, depicted is a block diagram of a voltage control 400 in a controller of a power subsystem. The voltage control 400 can be part of or can include components of the system 100, the power subsystem 200, or the control 300. The voltage control 400 can include at least one lead-lag filter 405 to apply to an input voltage component. The lead-lag filter 405 (also referred herein as a lead-lag compensator) may improve undesirable frequency response in the voltage control 400. The transfer function of the lead-lag filter 405 can be defined, for example, as:

$${H}_{1} ( s ) = \frac{{T}_{z} \cdot s + 1}{{T}_{P} \cdot s + 1}$$

wherein T_{z} and T_{P} denote compensation factors for lead-lag and s denotes the input voltage component in the Laplace domain.

The voltage control 400 can include at least one proportional (P) amplifier 410, at least one band pass filter (BPF) 415 (sometimes herein referred to as a resonant filter), and at least one aggregator 420 (sometimes herein referred to as signal summation). The proportional amplifier 410 and BPF 415 can be structured to be coupled in parallel between the lead-lag filter 405 and the aggregator 420. The proportional amplifier 410 can modify, boost, or otherwise amplify at least a portion of the input voltage component. The proportional amplifier 410 can have a transfer function of the following form:

$${H}_{2} ( s ) = {K}_{P}$$

wherein K_{P} denotes a proportional gain factor applied by the proportional amplifier 410. In addition, the BPF 415 can suppress one or more harmonics, ripples, or other artifacts of the input voltage component. The processing of the voltage component by the BPF 415 can be in parallel with the proportional amplifier 410. The BPF 415 can have a transfer function of the following form:

$${H}_{5} ( s ) = \frac{2 \cdot {K}_{R} \cdot {ω}_{c} \cdot s}{{s}^{2} + 2 \cdot {ω}_{c} \cdot s + {ω}_{0}^{2}}$$

wherein K_{R} denotes the resonant gain factor, ω_{c} denotes the passband frequency for the BPF, and ω_{y} denotes the center frequency about which the BPF is defined. The aggregator 420 can mix, combine, or otherwise add the voltage components modified by the proportional amplifier 410 and the BPF 415.

The voltage control 400 can also include at least one integral (I) amplifier 425, at least one unit filter 430, and at least one aggregator 435. The integral amplifier 425 and unit filter 430 can be structured to be in parallel with a direct connection between the aggregator 420 and the aggregator 435. The integral amplifier 425 can modify, boost, or otherwise amplify at least a portion of the input voltage component. The integral amplifier 425 and the unit filter 430 can have, for example, respective transfer functions of the following forms:

$${H}_{4} ( s ) = 1$$

$${H}_{3} ( s ) = {K}_{I} \cdot ( \frac{1}{s} )$$

wherein K₁ denotes the integral gain factor. The proportional amplifier 410, the integral amplifier 425, and the unit filter 430 together can have, for example, a transfer function of the following form:

$${H}_{234} ( s ) = {K}_{P} \cdot ( 1 + {K}_{I} ( \frac{1}{s} ) )$$

The aggregator 435 can mix, combine, or otherwise add the voltage component modified by the integral amplifier 425 and the unit filter 430 with the voltage component outputted by the aggregator 420.

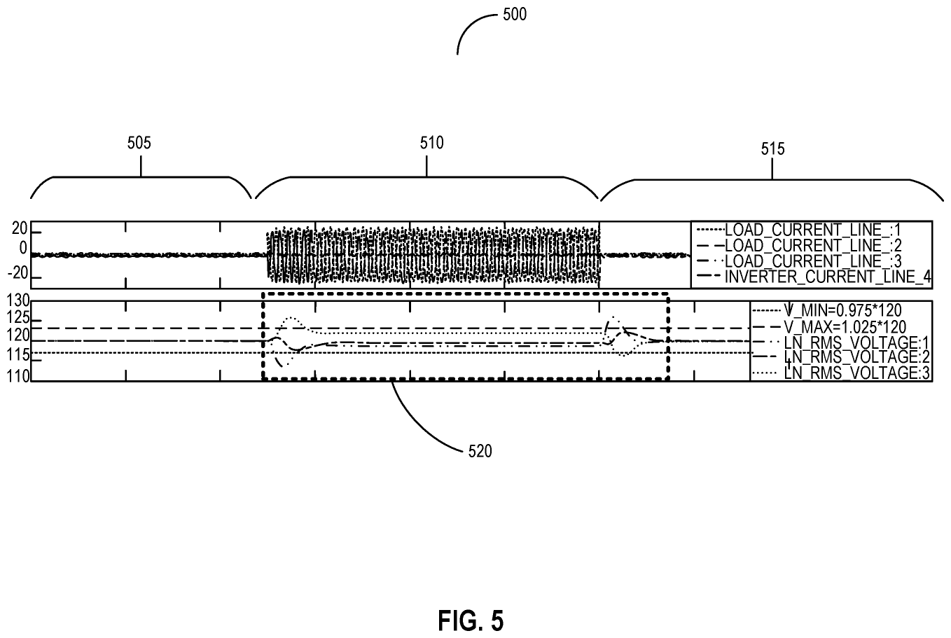

FIG. 5 depicts a graph 500 of output voltages and currents in response to coupling with an unbalanced load with the harmonic suppression control active. The graph 500 depicts the output voltages and currents from a controller (e.g., the controller 120) as detailed herein, spanning three time periods. The first time period 505 can correspond to a lack of any load (e.g., the load 115) connected with a power subsystem (e.g., the power subsystem 105). The second time period 510 can correspond to a coupling of an unbalanced 2.1 kW 1 PF A-N load with the power subsystem. The third time period 515 can correspond to a decoupling of the load connected with the power subsystem. In the transition between the first time period 505 and the second time period 510, the controller can experience power signals with harmonics and in response can suppress the harmonics using the band pass filter to stabilize the output voltage components. Similarly, in the transition from the second time period 510 to the third time period 515, the controller can experience power signals with harmonics and in response can null the harmonics using the band pass filter to stabilize the output voltage components.

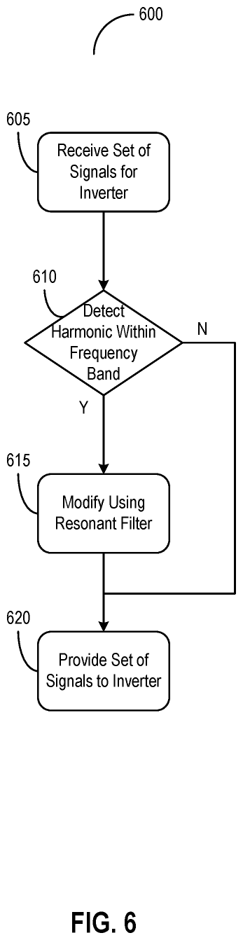

Referring now to FIG. 6, depicted is a flow diagram of a method 600 of regulating generator spatial harmonics. The method 600 can be implemented by or performed using any of the components discussed herein. In brief overview, under the method 600, one or more processors can receive a set of signals for an inverter (605). The one or more processors can detect whether a harmonic is present within a frequency band (610). If the harmonic is detected, the one or more processors can modify the set of signal using a set of resonant filters to suppress the harmonic and amplify a target frequency band (615). The one or more processors can provide the set of signals to the inverter (620).

In further detail, one or more processors (e.g., processors in the controller 120) can retrieve, identify, or otherwise receive a set of signals (e.g., the set of power signals 155) for an inverter (e.g., the inverter 125) (605). The set of signals can correspond to an electrical power conveyed between a power source (e.g., the power source 110) and a load (e.g., the load 115). Each signal can correspond to a respective component of the domain, such as direct (D), quadrature (Q), or zero (0) component in the DQ0 domain. The set of signals can correspond to a set of legs of the inverter.

The one or more processors can identify, determine, or otherwise detect whether a harmonic is present within a frequency band (e.g., the harmonic frequency band 160) (610). The harmonic can correspond to an unbalanced load and can be associated with a portion of a voltage component of a power signal. The one or more processors can select one or more frequency bands within which to scan for the harmonic based on the component in the domain of the power signal. When an amplitude in the monitored frequency band is greater than or equal to a threshold, the one or more processors can determine that the harmonic is present. Conversely, when an amplitude in the monitored frequency band is less than a threshold, the one or more processors can determine that the harmonic is absent.

If the harmonic is detected, the one or more processors can modify the set of signals by controlling, attenuating, or otherwise suppressing the harmonic of the voltage component (615). The one or more processors can filter the voltage component of the power signal in accordance with a resonant gain function. The resonant gain function can define a band pass filter (BPF) to attenuate or suppress the portion of the power signal in the frequency bands in which the harmonic is detected. The one or more processors can determine an adjustment value in accordance with the resonant gain function. With the determination of the adjustment value, the one or more processors can apply the adjustment value to the portion of the voltage component within the frequency band to suppress the harmonic frequency.

While suppressing the harmonic frequency, the one or more processors can increase, boost, or otherwise amplify the voltage component in a target frequency band (e.g., the desired frequency band 165). The one or more processors can also determine the adjustment value in accordance with the resonant gain function. The band pass filter defined by the resonant gain function can amplify or maintain the portion of the voltage component within the target frequency band. With the determination of the adjustment value, the one or more processors can apply the adjustment value to amplify the portion of the voltage component of in the target frequency band.

The one or more processors can output, convey, or otherwise provide the set of signals (e.g., the output set of power signals 155″) to the inverter (620). In providing the set of signals, the one or more processors can translate, convert, or otherwise transform the set of signals from one domain (e.g., dq0 domain) to a target domain (e.g., abc domain). The one or more processors can also add a reference signal to the set of signals. Upon adding a reference signal, the one or more processors can perform rebalancing across the set of signals. The one or more processors can provide the set of modified signals to the corresponding set of legs of the inverter.

While this specification contains various implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, means the joining of two components directly or indirectly to one another. Such joining may be stationary (e.g., permanent) or moveable (e.g., removable or releasable). Such joining may be achieved with the two components, or the two components and any additional intermediate components, being integrally formed as a single unitary body with one another, or with the two components, or with the two components and any additional intermediate components, being attached to one another.

The terms “fluidly coupled to” and the like, as used herein, mean the two components or objects have a pathway formed between the two components or objects in which a fluid, such as air, reductant, an air-reductant mixture, exhaust gas, hydrocarbon, an air-hydrocarbon mixture, may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc., may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values herein are inclusive of their maximum values and minimum values unless otherwise indicated. Furthermore, a range of values does not necessarily require the inclusion of intermediate values within the range of values unless otherwise indicated.

It is important to note that the construction and arrangement of the various systems and the operations according to various techniques shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow.

What is claimed is:

1. A controller for handling unbalanced loads for power sources, comprising:
a computer-readable medium having instructions stored thereon; and
at least one processor configured to execute the instructions to:
receive a plurality of signals to be provided to a plurality of legs of an inverter;
identify an unbalanced load outside a frequency band for a first signal of the plurality of signals;
determine, responsive to the identification of the unbalanced load, an adjustment value in accordance with a resonant gain to be applied within the frequency band of the first signal; and
modify the first signal using the adjustment value to generate a second signal to provide to a leg of the plurality of legs of the inverter.

2. The controller of claim 1, wherein the at least one processor is further configured to execute the instructions to:
identify, from a plurality of components corresponding to the plurality of signals, a component corresponding to the first signal; and
determine, in accordance with identified component, the frequency band and the resonant gain to apply for the first signal to suppress voltage spatial harmonics.

3. The controller of claim 1, wherein the at least one processor is further configured to execute the instructions to:
identify the unbalanced load about at least one frequency of a plurality of defined frequencies for the first signal; and
determine, responsive to the identification of the unbalanced load, a second adjustment value to be applied about the frequency to suppress the unbalanced load.

4. The controller of claim 1, wherein the at least one processor is further configured to execute the instructions to select, based on a component of a plurality of components corresponding to the first signal, a second frequency band within which to scan for the unbalanced load.

5. The controller of claim 1, wherein the at least one processor is further configured to execute the instructions to:
determine that none of the plurality of signals corresponds to a reference signal; and
generate, responsive to determining that none of the plurality of signals corresponds to the reference signal, the reference signal set to a defined value to add to the plurality of signals.

6. The controller of claim 1, wherein the at least one processor is further configured to execute the instructions to transform the plurality of signals in a first domain to a second plurality of signals in a second domain with the addition of at least one reference signal for a corresponding leg of the plurality of legs, the reference signal to be used to balance across the second plurality of signals.

7. The controller of claim 1, wherein the at least one processor is further configured to execute the instructions to regulate the first signal via a proportional-integral (PI) controller, parallel to adjustment value applied to the first signal.

8. A system for providing electrical power, comprising:
a power source configured to provide electrical power;
a controller structured to be coupled with the power source, the controller configured to convert the electrical power to a first plurality of signals;
an inverter structured to be coupled with the controller, the inverter comprising a plurality of legs to receive a second plurality of signals; and
a plurality of component controls in the controller, each of the plurality of component controls structured to be coupled with the inverter, at least one component control of the plurality of component controls configured to:
detect a ripple within a frequency band of a first signal of the first plurality of signals;
apply, in accordance with a gain function defined for the at least one component control, an adjustment value to suppress the ripple within the frequency band; and
provide the first signal as a corresponding signal in the second plurality of signals for the plurality of legs of the inverter.

9. The system of claim 8, wherein the at least one component control is further configured to apply, in accordance with the gain function, a second adjustment value to increase a portion of the signal within a second frequency band.

10. The system of claim 8, wherein the at least one component control is further configured to select, based on a component of a plurality of components defined for the at least one component control, the frequency band of a plurality of frequency bands within which to monitor for the ripple.

11. The system of claim 8, wherein further comprising a signal balancer in the controller to convert the first plurality of signals in a first domain to the second plurality of signals in a second domain with the addition of at least one reference signal for a reference leg of the plurality of legs of the converter.

12. The system of claim 8, wherein the component control is structured to be electrically coupled in parallel with at least one component in the controller relative to the inverter.

13. The system of claim 8, wherein the component control is further configured to adjust the first plurality of signals in accordance with a proportional-integral (PI) control function.

14. The system of claim 8, wherein the power source further comprises at least one of a generator set, a battery pack, a solar panel, a power plant, or a renewable fuel power source.

15. A method of regulating generator spatial harmonics, comprising:
receiving, by one or more processors, a plurality of signals to be provided to a plurality of legs of an inverter;
detecting, by the one or more processors, a generator spatial harmonic within a frequency band for a signal of the plurality of signals;
modifying, by the one or more processors, responsive to detecting the targeted harmonics, the signal using a resonant filter to suppress the generator spatial harmonic; and
providing, by the one or more processors, the modified signal to a leg of the plurality of legs of the inverter.

16. The method of claim 15, further comprising:
identifying, by the one or more processors, from a plurality of components corresponding to the plurality of signals, a component corresponding to the signal; and
selecting, by the one or more processors, from a plurality of frequency bands, the frequency band within which to scan for the generator spatial harmonics based on the component.

17. The method of claim 15, further comprising:
transforming, by the one or more processors, the plurality of signals in a first domain to a second plurality of signals in a second domain; and
adding, by the one or more processors, to the second plurality of signals, a reference signal for a corresponding leg of the plurality of legs.

18. The method of claim 15, further comprising adjusting, by the one or more processors, the plurality of signals with the modified signal using a proportional-integral (PI) control function.

19. The method of claim 15, wherein receiving further comprises receiving the plurality of signals from a power source comprising at least one of a generator set, a battery pack, a solar panel, a power plant, or a renewable fuel power source.

20. The method of claim 15, wherein modifying further comprises increasing, using the resonant gain, a portion of the signal within a second frequency band.
